(19) United States
(12) Patent Application Publication
(10) Pub. No.: US 2023/0219093 A1
(43) Pub. Date: Jul. 13, 2023

(54) TEST KIT AND TEST SYSTEM

(71) Applicant: Canon Medical Systems Corporation, Otawara-shi (JP)

(72) Inventors: Satoshi YAMANE, Nasushiobara (JP); Takeshi YAMAUCHI, Utsunomiya (JP); Shoichi KANAYAMA, Otawara (JP)

(73) Assignee: Canon Medical Systems Corporation, Otawara-shi (JP)

(21) Appl. No.: 18/153,584

(22) Filed: Jan. 12, 2023

(30) Foreign Application Priority Data
Jan. 13, 2022 (JP) 2022-003879

(51) Int. Cl. B01L 3/00; B01L 1/00

(52) U.S. Cl. CPC B01L 3/502784; B01L 1/52; B01L 3/502715; B01L 2300/0663; B01L 2300/0816; B01L 2300/0861

(57) ABSTRACT

According to one embodiment, a test kit includes a dropping device is configured to drop a droplet and a test device. The test device includes a reaction tank having an opening into which the droplet is dropped, the reaction tank being configured to house the droplet. The reaction detector is arranged below the opening inside the reaction tank and comprising a surface with a substance to be bound to a detection target substance. The reaction tank has an internal volume substantially equal to twice an amount of the droplet, or smaller than or equal to twice the amount.

### CROSS-REFERENCE TO RELATED APPLICATIONS

This application is based upon and claims the benefit of priority from Japanese Patent Application No. 2022-003879, filed Jan. 13, 2022, the entire contents of which are incorporated herein by reference.

### FIELD

Embodiments described herein relate generally to a test kit and a test system.

### BACKGROUND

Tests such as an infectious disease test and a blood test require collection of specimens such as mucosal epithelium and blood, and are an invasive medical procedure. Thus, minimal implementation is desired. In addition, in many cases, in tests for newborns, only a very small amount of specimen can be collected. Thus, there is a demand for tests using a very small amount of specimen. As described above, a test item for which invasive specimen collection is required and a test item for which only a very small amount of a sample can be obtained require a test to be implemented using a very small amount of a sample; however, a test using a very small amount of sample has a problem wherein a surface tension of liquid hinders transmission of the very small amount of sample to a reaction detection area.

### BRIEF DESCRIPTION OF THE DRAWINGS

FIG. 1 is a view showing an exemplary appearance of a test device according to a first embodiment.

FIG. 2 is a view showing the exemplary appearance of the test device according to the first embodiment.

FIG. 3A is a view showing an exemplary sensor chip according to the first embodiment.

FIG. 3B is a view showing the exemplary sensor chip according to the first embodiment.

FIG. 4 is a view showing an exemplary dropping device according to the first embodiment.

FIG. 5 is a view showing a first design example of the test device according to the first embodiment.

FIG. 6 is a view showing a second design example of the test device according to the first embodiment.

FIG. 7 is a view showing a third design example of the test device according to the first embodiment.

FIG. 8 is a view showing a fourth design example of the test device according to the first embodiment.

FIG. 9 is a view showing a fifth design example of the test device according to the first embodiment.

FIG. 10 is a view showing a state transition of a droplet when a sample liquid is dropped into the test device according to the first embodiment.

FIG. 11 is a block view showing a test system according to a second embodiment.

FIG. 12 is a flowchart showing operation of the test system according to the second embodiment.

FIG. 13 is a flowchart showing an exemplary chronological change in light intensity of emitted light according to the second embodiment.

### DETAILED DESCRIPTION

In general, according to one embodiment, a test kit includes a dropping device is configured to drop a droplet and a test device. The test device includes a reaction tank having an opening into which the droplet is dropped, the reaction tank being configured to house the droplet. The reaction detector is arranged below the opening inside the reaction tank and comprising a surface with a substance to be bound to a detection target substance. The reaction tank has an internal volume substantially equal to twice an amount of the droplet, or smaller than or equal to twice the amount

Hereinafter, a test device, a test kit, and a test system according to a present embodiment will be described with reference to the drawings. The description of the embodiments will assume that components or portions having the same reference signs are adapted to operate in the same manner, and redundant explanations will be omitted as appropriate.

### First Embodiment

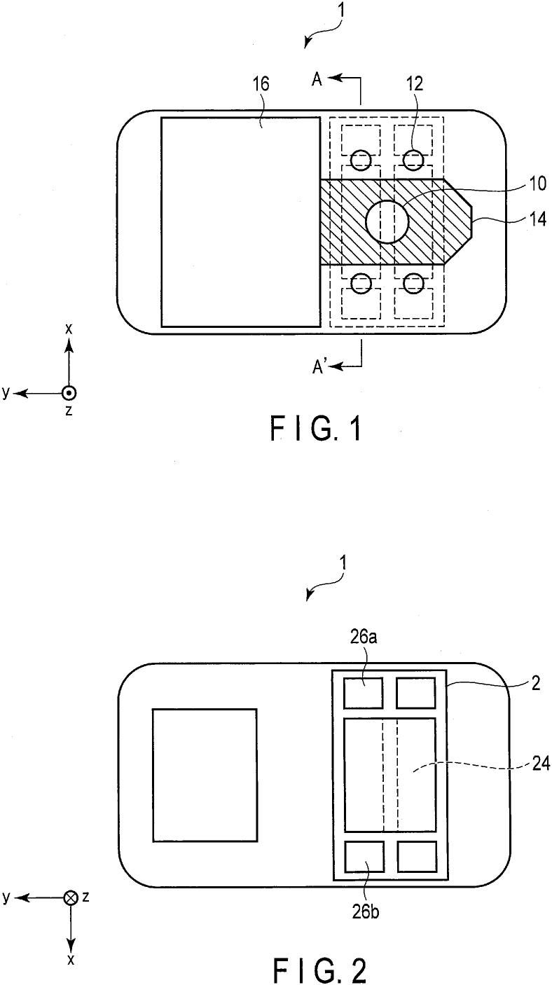

An exemplary appearance of a test device according to a first embodiment will be described with reference to FIG. 1 and FIG. 2.

FIG. 1 is a top view showing the upper surface (front surface) of a test device 1, and FIG. 2 is a bottom view showing a lower surface (rear surface) of the test device 1.

The test device 1 has, on its upper surface, an opening 10 and four bores 12. The opening 10 is provided to allow a sample liquid to be dropped into the test device using a dropping device to be described later. The test device 1 is arranged in such a manner that the vicinity of the center of the reaction detector of the sensor chip 2 to be described later is positioned just below the opening 10. The test device 1 is provided with four bores 12 in order to remove internal air that is pushed out according to dropping in a case where a sample liquid is dropped through the opening 10. The holes 12 may thus be referred to as air bores. In the example of FIG. 1, the four bores 12 are arranged; however, this is not a limitation. No bores 12 may be provided or 1 to 3 bores 12 or 5 or more bores 12 may be provided.

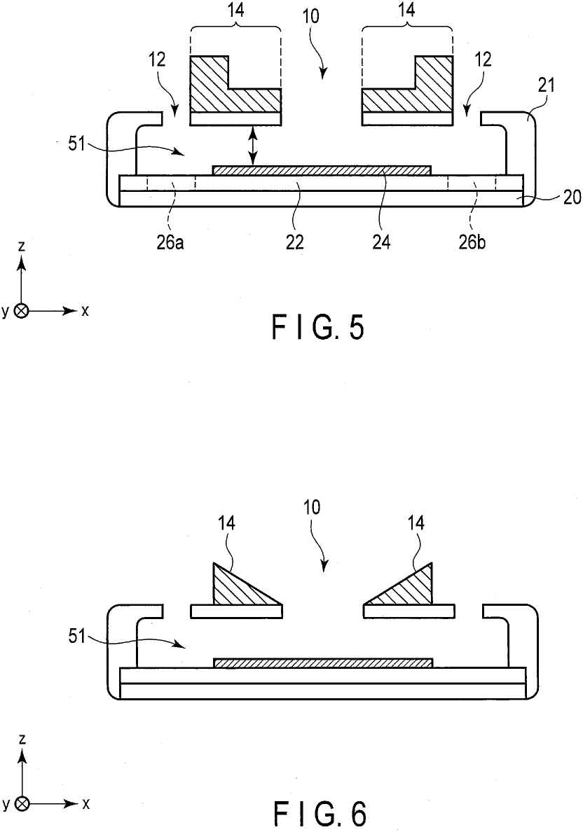

A first assisting structure 14 is formed around the opening 10. The first assisting structure 14 is a structure that assists in guiding a sample liquid to the opening 10 using the dropping device, and will be described later with reference to FIG. 5.

A label region 16 provided on the front surface of the test device 1 is a region in which a test item to be tested with the test device 1, a name for specifying a provider (subject) who has provided a specimen, etc. are filled in.

The sensor chip 2 is a chip for determining whether a measurement result of a detection target substance contained in the sample liquid is positive or negative. The sensor chip 2 is attached to the rear surface of the test device 1 with an adhesive material such as double-sided tape to thereby form a reaction tank to be described later.

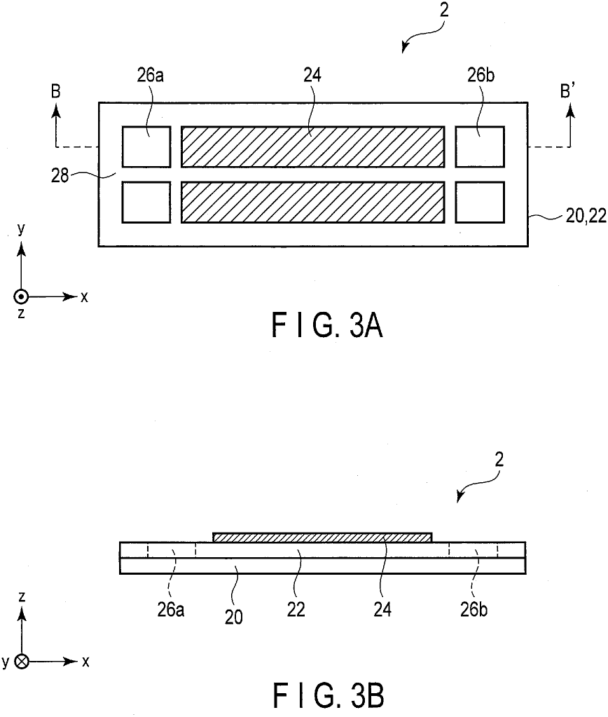

One example of the sensor chip 2 according to the present embodiment will be described in more detail with reference to FIG. 3A and FIG. 3B.

FIG. 3A is a top view of the sensor chip 2, and FIG. 3B is a cross-sectional view taken along the line B-B′ of the sensor chip 2.

The sensor chip 2 contains a transparent substrate 20, an optical waveguide 22, reaction detectors 24 (also referred to as detection regions), gratings 26a, gratings 26b, and a non-reaction detector 28 (also referred to as a non-detection region).

The transparent substrate 20 has a structure for extracting light from the reaction detectors 24. For example, the transparent substrate 20 is made of resin or optical glass. The transparent substrate 20 allows incident light to pass therethrough to the optical waveguide. Furthermore, the transparent substrate 20 allows light that has passed through the optical waveguide 22 to pass to the outside. The transparent substrate is made of a material having a refractive index different from that of the optical waveguide 22, and allows light to be totally reflected from the interface with the optical waveguide 22. In other words, the transparent substrate functions as a clad that confines light within the optical waveguide 22. Furthermore, the transparent substrate 20 physically protects the optical waveguide 22.

The optical waveguide 22 is stacked on the transparent substrate 20, and light passes through the inside of the optical waveguide 22. That is, the optical waveguide 22 functions in a manner similar to the core (core material) of optical fibers. The optical waveguide 22 is made of a light transmissive material such as, e.g., resin or optical glass. Examples of the resin include phenol resin, epoxy resin, and acrylic resin.

Each of the reaction detectors 24 is positioned at the center of the sensor chip 2 and is a region in which an antibody is fixed (coated) on the upper surface of the optical waveguide 22. The reaction detector 24 has, on its surface, a substance that is bound to a detection target substance. Furthermore, the surface of the reaction detector 24 may be processed so as to have lyophilicity. The term “lyophilicity” refers to a property with which a contact angle with respect to a liquid is less than approximately 90 degrees, and is also referred to as hydrophilicity in the case of the liquid being water.

The grating 26a is configured to reflect (diffract) light, and is arranged at a position where the grating 26a causes light to enter the optical waveguide 22.

The grating 26b is configured to reflect (diffract) light, and is arranged at a position where the grating 26b reflects light inside the optical waveguide 22 to the outside.

In the upper surface of the optical waveguide 22, the non-reaction detector 28 is a portion other than the reaction detectors 24, and is formed in such a manner that each of the reaction detectors 24 serves as an independent region. That is, FIGS. 3A and 3B show the example in which the reaction detectors are provided in two rows, so that the non-reaction detector 28 corresponds to a region that surrounds the periphery of the reaction detector 24 for each of the rows. Furthermore, the non-reaction detector 28 is formed in such a manner as to have liquidphobicity (liquid repellency). The term “liquid repellency” refers to a property with which a contact angle with respect to a liquid is greater than approximately 90 degrees, and is also referred to as liquid repellency in the case of the liquid being water. A liquid is repelled in the region of the non-reaction detector 28. Thus, the non-reaction detector 28 plays a role of retaining the sample liquid in the reaction detectors 24 having lyophilicity.

Furthermore, the example shown in FIG. 3A and FIG. 3B assumes that the reaction detectors 24 are formed in two rows; however, the reaction detector 24 may be formed in one row or may be formed in three or more rows. Antibodies coated on the reaction detectors 24 may be different or the same for each row. Particularly in a case where the reaction detectors 24 are formed in three or more rows, antibodies may be the same between at least two rows.

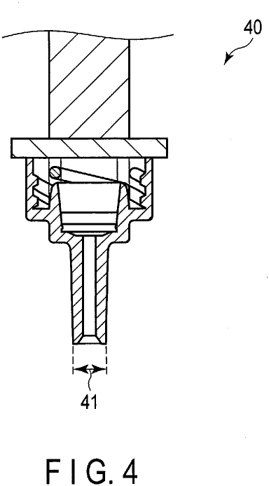

Next, one example of the dropping device for use in dropping a sample liquid into the test device 1 is shown in FIG. 4.

FIG. 4 shows the cross-sectional shape of a tip of the dropping device 40. The dropping device 40 is designed to have a tip outer diameter 41 of a predetermined size such as, e.g., 3.9 mm. In the example shown in FIG. 4, the tip of the dropping device 40 is designed to have a tapered shape in order to make a droplet larger than the tip outer diameter 41. However, the tip of the dropping device 40 is not limited to this example and may have a general nozzle shape.

A combination of the test device 1 and the dropping device 40 is also called a test kit.

Next, a first design example of the test device 1 according to the first embodiment will be described with reference to FIG. 5.

FIG. 5 is a cross-sectional view of the test device 1 taken along the line A-A′ in FIG. 1. In the case where the reaction detectors 24 are arranged in two rows, for example, the opening 10 may not exist in the cross-sectional view taken along the line A-A′. However, for convenience of explanation, this cross-sectional view shows the opening 10 in order to indicate its position relative to the reaction detectors 24 when viewed in a Y direction.

FIG. 5 shows the transparent substrate 20, a housing 21, the optical waveguide 22, the reaction detector 24, the gratings 26a and 26b, and the first assisting structure 14. The housing 21 is made of resin, for example. The lower surface of the housing 21 is open, and the sensor chip 2 having the optical waveguide 22 formed by thin film technology is fitted onto the transparent substrate 20 from the lower surface side of the housing 21. As a result, the housing 21 of the test device 1 and the sensor chip 2 form a reaction tank 51. The reaction tank 51 is configured in such a manner that the upper surface of the housing 21 forms the upper surface of the reaction tank 51, the housing 21 forms the side surface of the reaction tank 51, and the upper surface of the optical waveguide 22 (front surface of the sensor chip 2) containing the reaction detector 24 forms the lower surface of the reaction tank 51. The test device 1 can house a sample liquid in its inside, that is, in the reaction tank 51.

The size of the opening 10 is determined according to the tip outer diameter of the dropping device 40. For example, the lower limit of the size of the opening 10 may be designed to be larger than the tip outer diameter 41 of the dropping device 40 and than the diameter of a droplet of a sample liquid dropped from the dropping device. If the size of the opening is too large, the test device 1 may be affected by external light during reaction detection. Thus, the upper limit of the size of the opening may be determined as appropriate in consideration of the tip outer diameter 41 of the dropping device and a state of reaction detection. For example, in the case of the opening 10 formed into a circular shape, its diameter ranges preferably from 3.0 to 7.0 mm, more preferably from 4.0 to 6.0 mm (5.0±1.0 mm). The opening 10 is not limited to a circular shape, and may take any shape such as a polygon such as a triangle or a square, or a star shape, as long as the diameter of the opening 10 is larger than the diameter of a droplet of a sample liquid to be dropped. The opening 10 formed into a shape other than a circular shape is presumed to have an opening area equivalent to that of the opening having a circular shape.

The distance between the inner wall side of the upper surface of the test device 1 (that is, the top surface of the reaction tank 51) and the reaction detector 24 (in other words, the height of the reaction tank 51) is designed in such a manner that the inner wall side of the upper surface of the test device 1 and the reaction detector 24 are close to each other. For example, the aforementioned distance is designed to be approximately 1±0.2 mm. This achieves a reduction in internal volume (capacity) of the reaction tank 51. Herein, the internal volume of the reaction tank 51 is the internal volume when it is assumed that the opening 10 is plugged by a flat surface at the same height as that of the top surface. For example, the reaction tank 51 is designed to have any internal volume as long as the internal volume is substantially equal to twice the amount of a droplet dropped by the dropping device 40 or is smaller than or equal to twice the aforementioned amount. Specifically, the reaction tank 51 may be designed to have an internal volume equivalent to one or two drops of a sample liquid dropped by the dropping device 40, for example. That is, in the case where a sample liquid is dropped into the reaction tank 51 through the opening 10 by the dropping device 40, the reaction tank 51 enters a filled state in which it is filled with a small number of droplets (one or two droplets of the sample liquid). The filled state is, for example, a state in which the upper and lower surfaces of the reaction tank 51 are in contact with a droplet.

A droplet may not enter the reaction tank 51 if it is too small in height, and a droplet may not appropriately spread over the reaction detector 24 in the reaction tank 51 if it is too large in height. Therefore, it is preferable that the reaction tank 51 be appropriately designed to have a height based on the aforementioned height of about 1±0.2 mm such that the reaction tank 51 can be filled with a sample liquid by dropping a small number of droplets.

The first assisting structure 14 protrudes from the surface of the housing 21 toward the outside of the housing 21 and is arranged around the opening 10. The first assisting structure 14 has a structure that guides or drops the sample liquid toward the opening 10 even in a case where the sample liquid from the dropping device 40 is dropped outside the opening 10. For example, in the example of FIG. 5, the first assisting structure 14 has a concave structure centered on the opening. The concave structure of the first assisting structure 14 allows the first assisting structure 14 to play the role of a saucer even in the case where the sample liquid is dropped to the extent that it overflows from the reaction tank 51. This increases the probability that the sample liquid will be retained in the concave structure.

Next, a second design example of the test device 1 according to the first embodiment will be described with reference to FIG. 6.

The first assisting structure 14 according to the second design example has a tapered shape that widens from the opening 10 toward the upper surface of the test device 1. This enables, even in the case where the sample liquid overflows from the reaction tank 51, the sample liquid to be retained in the tapered shape of the first assisting structure 14, and a droplet to be dropped more easily into the opening 10 than the first design example.

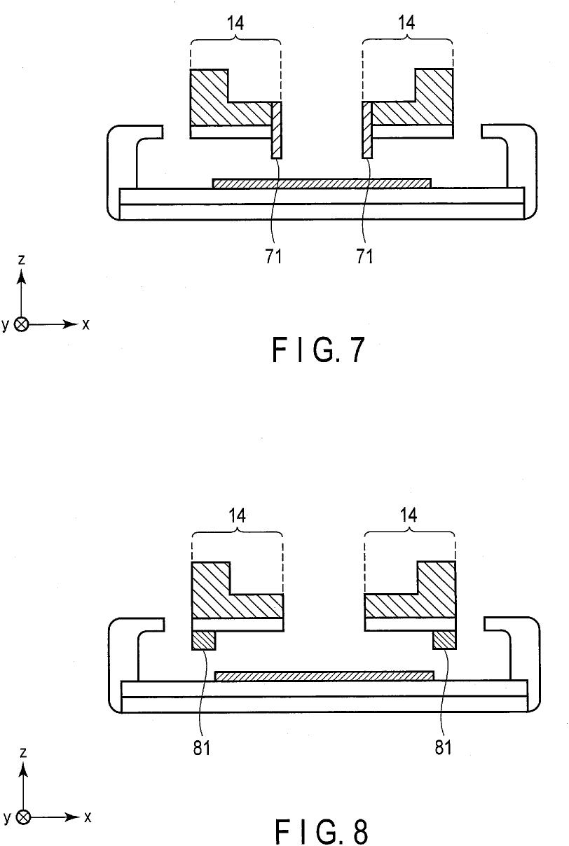

Next, a third design example of the test device 1 according to the first embodiment will be described with reference to FIG. 7.

In the third design example, in addition to the first assisting structure 14 according to the first design example shown in FIG. 5, a second assisting structure 71 is arranged. The second assisting structure 71 is arranged to extend from the opening 10 to the inside of the reaction tank 51 and is configured to assist in guiding a droplet to the reaction detector 24. That is, the second assisting structure 71 is formed in a cylindrical shape extending from the opening 10 to the inside of the reaction tank 51. This enables, even in the case where the sample liquid is dropped near the outer edge of the opening, a droplet to fall along the second assisting structure 71 and thus be easily guided to the reaction detector 24 in the reaction tank 51.

Next, a fourth design example of the test device 1 according to the first embodiment will be described with reference to FIG. 8.

The fourth design example contains, in addition to the first assisting structure 14 according to the first design example shown in FIG. 5, a third assisting structure 81 formed close to the bores 12 on the top surface of the reaction tank 51 and protruding from the aforementioned top surface toward the inside of the reaction tank 51. In other words, the fourth design example has a concave structure centered on the opening 10 and extending to the reaction tank 51. The third assisting structure 81 provides assistance so that a sample liquid is retained as much as possible in the reaction detector 24 positioned on the lower surface of the reaction tank 51.

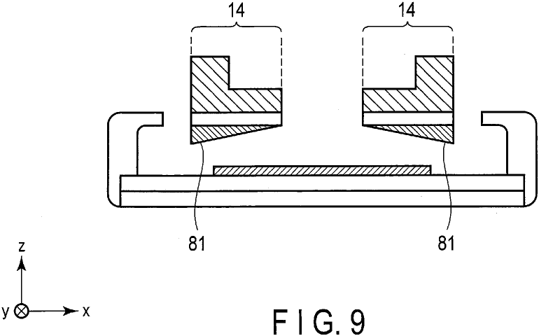

Next, a fifth design example of the test device 1 according to the first embodiment will be described with reference to FIG. 9.

In a fifth design example, the third assisting structure 81 has a tapered shape as in the first assisting structure 14 shown in FIG. 6. Such a tapered shape of a third assisting structure 81 realizes assistance in such a manner that the sample liquid is retained as much as possible in the reaction detector 24, as in the fourth design example.

Each of the first assisting structure 14, the second assisting structure 71, and the third assisting structure 81 may be formed integrally with the test device or may be formed of a synthetic resin and adhered to the test device 1.

At least one of the first assisting structure 14 and the second assisting structure 71 may have a surface structure that suppresses a surface tension of a droplet of the sample liquid. For example, at least one of the first assisting structure 14 and the second assisting structure 71 may have at least one of a fine uneven structure and a lyophilic structure. This prevents a droplet from remaining in each assisting structure and enhances guidance of the droplet to a guidance destination targeted by each assisting structure.

Similarly, the top surface of the reaction tank 51 may have a surface structure that suppresses a surface tension of a droplet of the sample liquid, for example, at least one of the fine uneven structure and the lyophilic structure. This enables a droplet to spread with wetting action over the reaction tank 51, that is, to easily spread in the x-y plane direction.

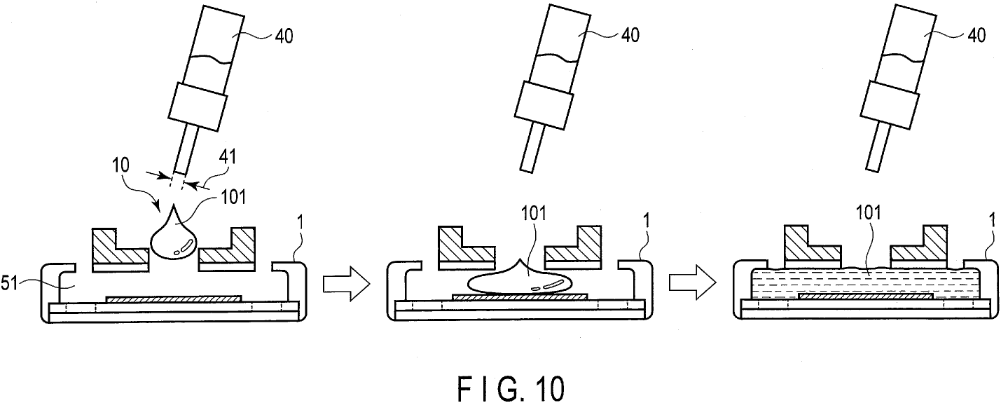

Next, a state transition of a droplet when the sample liquid is dropped into the reaction tank 51 of the test device 1 will be described with reference to the conceptual view in FIG. 10.

The left part of FIG. 10 shows a state immediately after the dropping device 40 drops a sample liquid 101. The opening 10 of the test device 1 is larger than the tip outer diameter 41 of the dropping device 40, so that a user can easily drop the sample liquid 101 with respect to the opening 10.

The center part of FIG. 10 shows a state in which the sample liquid 101 expands inside the reaction tank 51 after the sample liquid 101 drops. Because of the capillarity phenomenon caused by the reaction tank 51 being thin, in addition to lyophilicity on the surface of the reaction detector 24, the sample liquid 101 immediately spreads with wetting action over the entire surface of the reaction detector 24.

The right part of FIG. 10 shows a state in which the reaction tank 51 is filled with the sample liquid 101. As described above, with one droplet dropped from the dropping device 40, the reaction tank 51 is sufficiently filled with the sample liquid 101.

According to the first embodiment described above, the opening of the test device is designed to be larger than the tip outer diameter of the dropping device, and the internal volume of the reaction tank formed by the casing of the test device and the sensor chip is designed to have a size that can be filled with a very small number of droplets dropped from the device, that is, a size substantially equal to the number of droplets, or smaller than or equal to the aforementioned amount. Furthermore, the reaction detector on the surface of the sensor chip is processed so as to have lyophilicity. By this, dropping about one or two droplets of a sample liquid from the opening causes the sample liquid to spread over the reaction detector, thereby enabling the reaction tank to be filled with the sample liquid. As a result, since a dropping operation of a sample liquid by the dropping device is required only one time, convenience can be improved. Furthermore, since a very small amount of a sample liquid can be quickly guided to the reaction tank without the need for other liquid droplet guidance mechanisms, efficiency in inspection and analysis can be improved.

### Second Embodiment

A second embodiment will describe a test system that tests a sample liquid by using the test device according to the first embodiment.

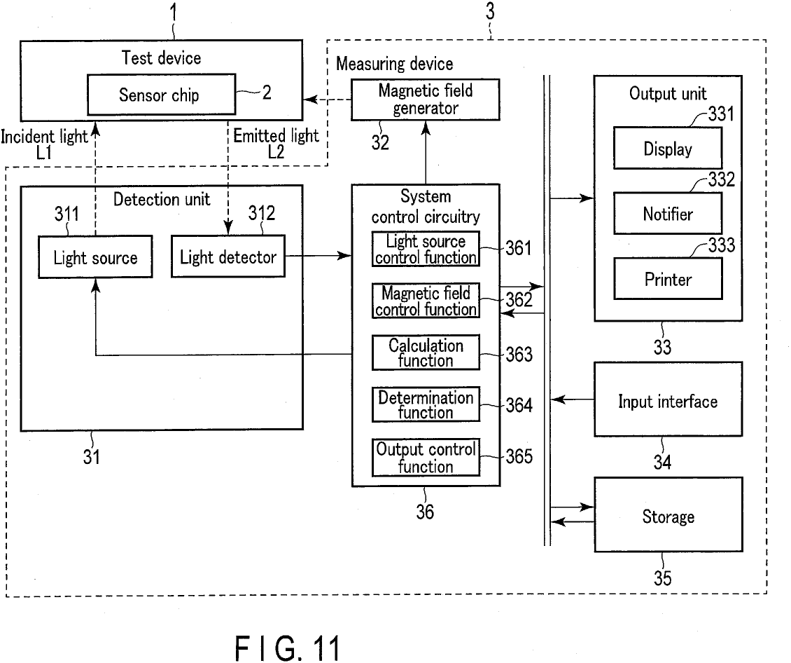

The test system according to the second embodiment will be described with reference to the block diagram of FIG. 11.

The test system includes the inspection device 1 according to the first embodiment and a measuring device 3. The test device 1 is attachably detachable with respect to the measuring device 3.

Herein, a plurality of first antibodies are immobilized on the reaction detector 24 of the test device 1, in other words, on the upper surface of the optical waveguide 22. The first antibody is a substance that specifically reacts with an antigen contained in a detection target substance through an antigen-antibody reaction.

Furthermore, it is assumed that the sample liquid dropped onto the test device 1 is a mixed liquid of a sample solution and a reagent. The sample solution contains a detection target substance containing an antigen. The reagent contains a reagent component. The reagent component contains, for example, a second antibody that specifically reacts with an antigen through an antigen-antibody reaction, and magnetic particles on which the second antibody is immobilized. At least some portions of the magnetic particles are made of a magnetic material such as magnetite. In the magnetic particles, for example, particles made of the magnetic material have their surfaces coated with a polymer material. The magnetic particles may be configured such that surfaces of the particles made of the polymer material are coated with a magnetic material. Any magnetic particle may be used as long as it is dispersible in the sample liquid.

The reagent component shifts in a dispersible manner in the sample liquid with which the reaction tank 51 is filled. Therefore, magnetic particles are selected in such a manner that the gravity exerted thereon is larger than the buoyancy in the sample liquid exerted in an opposite direction to the aforementioned gravity. The magnetic particles on which the second antibody is immobilized are immobilized in the vicinity of the upper surface of the optical waveguide 22 by the second antibody being bound to the first antibody via an antigen. The second antibody may be the same as or different from the first antibody.

The measuring device 3 contains a detection unit 31, a magnetic field generator 32, an output unit 33, an input interface 34, a storage 35, and a system control unit 36.

The detection unit 31 includes a light source 311 and a light detector 312.

The light source 311 adopts diodes such as LED’s (Light Emitting Diode), a lamp such as a xenon lamp, etc. The light source 311 is arranged at a position where it enables light to enter the optical waveguide 22 toward the grating 26a of the test device 1. The light source 311 makes incident light L1 enter the optical waveguide 22 through the transparent substrate 20 of the test device 1. The incident light L1 enters the optical waveguide 22 and is diffracted by the grating 26a. The incident light L1 diffracted by the grating 26a propagates through the inside of the optical waveguide 22 while repeating total reflection, thereby reaching the grating 26b. The incident light that has reached the grating 26b is diffracted by the grating 26b and is emitted as an emitted light L2 with a predetermined angle from the optical waveguide 22 to the outside. Instead of the light source 311, a generator other than a light generator, such as an electromagnetic wave generator may be used.

The light detector 312 outputs an electrical signal based on a state of reaction in the reaction tank 51 housing the sample liquid therein. Specifically, the light detector 312 detects the emitted light L2 to be emitted to the outside of the optical waveguide 22, and generates an electrical signal indicating the intensity of the detected emitted light L2, that is, digital data on the light detection intensity. The digital data on the light detection intensity generated by the light detector 312 is supplied to the system control unit 36.

The magnetic field generator 32 promotes the reaction of the sample liquid in the reaction tank 51 by applying a magnetic field to the reaction tank 51 of the test device 1 under the control of the system control unit 36. The magnetic field generator 32 generates energy that promotes binding via an antigen between the second antibody immobilized on the magnetic particles and the first antibody immobilized on the upper surface of the optical waveguide 22. Specifically, the magnetic field generator 32 has an upper magnetic field generator and a lower magnetic field generator. The magnetic field generator 32 also has a drive circuit (not shown). The upper magnetic field generator and the lower magnetic field generator are respectively constituted by a permanent magnet and an electromagnet, for example.

The output unit 33 includes a display 331, a notifier 332, and a printer 333.

The display 331 outputs data to a general external display device such as a liquid crystal display or an organic LED (OLED) display. Under the control of the system control circuitry 36, the display 331 displays various operation screens, information indicating the light intensity of the emitted light L2 supplied from the light detector 312, chronological data of the information indicating the light intensity, and a measurement result of a detection target substance. The measurement result is, for example, the concentration, weight, or number of antigens.

The notifier 332 is, for example, a speaker. The notifier 332 notifies an operator of a measurement result of a detection target substance under the control of the system control unit 36.

Under the control of the system control circuitry 36, the printer 333 prints, for example, various operation screens output from the display 331, information indicating the light intensity of the emitted light L2 supplied from the light detector 312, chronological data of the information indicating the light intensity, and a measurement result of a detection target substance.

The input interface 34 is realized by, for example, a trackball, switch buttons, a mouse, a keyboard, a touch pad which allows an input operation through contacting its operation screen, and a touch panel display which integrates a display screen and a touch pad. The input interface 34 outputs an operation input signal according to an operator’s operation to the system control circuitry 36. In the present embodiment, the input interface 34 is not limited to physical operating components such as a mouse and a keyboard. Examples of the input interface 34 include an electric-signal processing circuit that receives an electric signal corresponding to an input operation from an external input device provided separately from the device, and outputs the received electric signal to the processing circuit 36.

The storage 35 has a magnetic or optical storage medium, or a processor-readable storage medium such as a semiconductor memory. The storage 35 stores a program to be executed by a circuit of the measuring device 3 according to the present embodiment. The storage 35 may be configured in such a manner that a program and data in the storage medium thereof are partially or entirely downloaded via an electronic network.

The storage 35 stores information indicating the light intensity of the emitted light L2 supplied from the light detector 312, chronological data of the information indicating the light intensity, and a measurement result of a detection target substance serving as a measurement target.

The storage 35 stores, for example, a storage medium such as an HDD or an SSD, and stores setting information for measuring the detection target substance. The setting information includes, for example, information that defines timings of executing predetermined processing required for measurement. The timings of executing predetermined processing required for measurement include, for example, a timing at which application of the lower magnetic field is started, a timing at which application of the lower magnetic field is stopped, a timing at which application of the upper magnetic field is started, and a timing at which determination is performed. Information defining these timings includes a relative elapsed time period from a predetermined time or an absolute time at which predetermined processing is executed. The relative elapsed time period from a predetermined time or the absolute time at which predetermined processing is executed may be obtained in advance empirically or experimentally.

The storage 35 stores a preset threshold value T_{A}. The threshold value T_{A} is a threshold value for light intensity corresponding to the concentration of the detection target substance. The threshold value T_{A} is used to determine a qualitative state of the detection target substance. The qualitative state is, for example, the degree of positivity or negativity indicated by a measurement result. The threshold value T_{A} is used to make a final judgment as to whether or not the probability that the measurement result of a detection target substance is positive is high. The threshold T_{A} may be a plurality of stepwise threshold values. That is, comparison of the light intensity contained in digital data with the plurality of stepwise thresholds realizes a determination indicative of a more detailed measurement result.

The system control unit 36 is, for example, a processor configured to control each constituent circuit of the measuring device 3. The system control unit 36 functions as the center of the measuring device 3. The system control circuitry 36 reads and executes each operation program from the storage 35, thereby implementing a light source control function 361, a magnetic field control function 362, a calculation function 363, a determination function 364, and an output control function 365.

The light source control function 361 controls the light source 311 and generates light under a predetermined condition. With the light source control function 361, the system control circuitry 36 continuously or intermittently generates the incident light L1 from the light source 311 during a period at least from the start of measurement to the end of measurement.

The magnetic field control function 362 controls the magnetic field generator 32 in accordance with a time schedule stored in advance in the storage 35, and switches the application state of energy that promotes the reaction in the reaction tank 51. Specifically, with the magnetic field control function 362, the system control circuitry 36 reads setting information from the storage 35, controls the magnetic field generator 32 based on the read setting information, and generates a magnetic field in the magnetic field generator 32.

The calculation function 363 performs various calculations based on the chronological digital data on the light intensity supplied from the light detector 312. With the calculation function 363, the system control circuitry 36 uses the supplied chronological digital data on the light intensity to calculate the average value of light intensity, the fluctuation rate of light intensity, the integrated value of fluctuation rate, etc.

The determination function 364 determines a qualitative state of the detection target substance based on the digital data of light intensity supplied from the light detector 312 during application of the upper magnetic field to be described later. With the determination function 364, the system control circuitry 36 reads setting information and the threshold value T_{A} from the storage 35. The system control circuitry 36 determines a qualitative state of the determination target substance in accordance with the execution timing contained in the read setting information. In the case where it is determined that the light intensity contained in the supplied chronological digital data on the light intensity is equal to or smaller than the threshold value T_{A}, the system control circuitry 36 determines, for example, a high probability that a measurement result of the detection target substance is positive. In the case where the light intensity contained in the digital data is greater than the threshold value T_{A}, the system control circuitry 36 determines, for example, a high probability that the measurement result of the detection target substance is weakly positive or is negative.

The output control function 365 controls the output unit 33 to output a determination result such as a qualitative state of the detection target substance with respect to an operator. With the output control function 365, the system control unit 36 controls the display 331 or the printer 333 to present the determination result to the operator. The presentation includes a method of displaying via a display and a method of printing using a printer. The system control unit 36 controls the notifier 332 to notify the operator of the determination result. The notifying includes a method of notifying with sound.

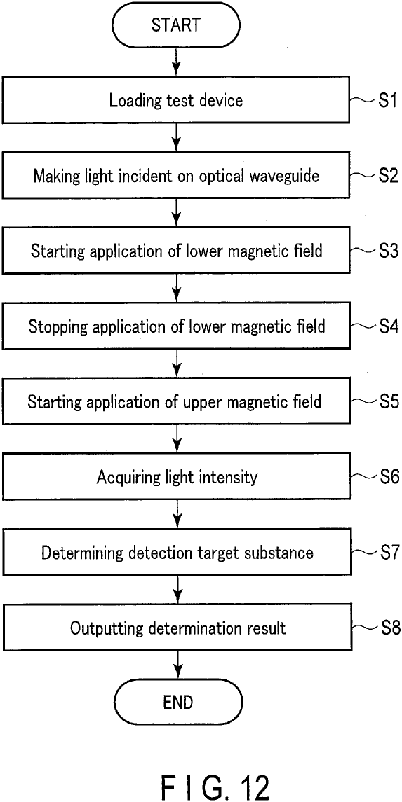

Next, one example of a specimen test using the test system according to the second embodiment will be described with reference to the flowchart shown in FIG. 12.

In step S1, the test device 1 is loaded in the measuring device 3, and a sample liquid is dropped thereon by the dropping device 40. As a result, the reaction tank 51 is filled with the sample liquid. A lower magnetic field may be applied by the magnetic field generator 32 at a timing at which the sample liquid is dropped into the opening 10 of the test device 1. Alternatively, a magnetic field may be fluctuated by the magnetic field generator 32 intermittently applying an upper magnetic field and a lower magnetic field in an alternate or random manner. Application of a magnetic field in this way makes it possible to promote dropping of a droplet into the reaction tank 51 and to shorten the time until the reaction tank 51 is filled with the sample liquid.

Furthermore, whether or not the reaction tank 51 is filled with the sample liquid can be determined based on, for example, whether or not the sample liquid is embedded up to the hole 12 of the test device 1. That is, if the sample liquid is embedded up to the position of the hole 12 of the test device 1, it is determined that the reaction tank 51 is filled with the sample liquid. If the sample liquid is not embedded up to the position of the hole 12, it is determined that the reaction tank 51 is not filled with the sample liquid. Therefore, with the determination function 364, the system control circuitry 36 determines whether or not the sample liquid has been embedded up to the position of the hole 12 by using image information obtained from an imaging device such as a camera or distance information obtained from a distance measuring device such as a laser. If it is determined that the reaction tank 51 is not filled with the sample liquid, the system control circuitry 36 may encourage a user to drop an additional sample liquid. Alternatively, in the case where the dropping device 40 is also configured to be loaded in the measuring device 3, for example, the system control circuitry 36 may automatically drop an additional sample liquid into the opening 10.

In step S2, by the light source 311 of the detection unit 31 emitting light of a constant intensity toward the optical waveguide 22 of the test device 1, the light of constant intensity enters the optical waveguide 22. The light of constant intensity is continuously made incident by the light source 311.

The magnetic field generator 32 starts applying a lower magnetic field. The light made incident on the optical waveguide 22 propagates through the inside of the optical waveguide 22 while repeating total reflection, and is emitted to the light detector 312 via the transparent substrate 20.

In the case where light propagates through the inside of the optical waveguide 22, a near-field light (evanescent light) is generated on the upper surface of the optical waveguide 22. In the reaction tank 51, a region in the vicinity of the surface of the optical waveguide 22, in which near-field light may be generated, is also called a sensing region. In the reaction tank 51, the first antibody immobilized on the upper surface of the optical waveguide 22 reacts with the antigen contained in the detection target substance in the sample solution. By reacting with the antigen, the first antibody is bound to the second antibody, too, which is immobilized on the magnetic particles contained in the reagent component. In this manner, the magnetic particles on which the second antibody is immobilized are held in the vicinity of the reaction detector 24 on the upper surface of the optical waveguide 22.

Light guided through the optical waveguide 22 is scattered and absorbed by magnetic particles immobilized in the vicinity of the upper surface of the optical waveguide 22. As a result, the light guided through the optical waveguide 22 is attenuated and emitted from the optical waveguide 22. That is, the incident light L1 is attenuated according to the amount of antigen that binds the first antibody and the second antibody immobilized on the magnetic particles, in other words, the amount of antigen housed in the reaction tank 51.

The light detector 312 receives light emitted from the optical waveguide 22 and supplies data on the light intensity to the system control circuitry 36 at predetermined time intervals.

In step S3, the magnetic field generator 32 starts applying a lower magnetic field under the control of the system control circuitry 36. Specifically, the lower magnetic field generator arranged below the test device 1 uniformly generates a vertical downward magnetic field in a horizontal direction. Herein, the vertically downward magnetic field is energy for promoting the reaction in the reaction tank 51. In accordance with the generated vertically downward magnetic field and gravity, the magnetic particles on which the second antibody is immobilized are aligned along magnetic lines of force, and descend upon receipt of a vertically downward force. The second antibody is bound to the first antibody immobilized on the reaction detector 24 located on the lower surface of the reaction tank 51 via the light source.

In step S4, the magnetic field generator 32 stops applying a lower magnetic field at a predetermined timing under the control of the system control circuitry 36.

In step S5, the magnetic field generator 32 starts applying an upper magnetic field under the control of the system control circuitry 36. Specifically, the upper magnetic field generator is located above the test device 1 when the test device is loaded in the measuring apparatus 3. The upward magnetic field generator uniformly generates a vertically upward magnetic field in the horizontal direction in the reaction tank 51. With the vertically upward magnetic field thus generated, the magnetic particles on which the second antibody is immobilized rises upon receipt of a vertically upward force. At this time, the upper magnetic field generator selectively moves the magnetic particles on which the second antibody is immobilized away from the sensing region by generating a magnetic field of predetermined strength. That is, by the upper magnetic field generator adjusting the strength of the magnetic field to be generated, it is possible to retain in the sensing region only the magnetic particles on which the second antibody that is bound, via the antigen, to the first antibody immobilized on the upper surface of the optical waveguide 22.

In step S6, at a timing at which the reaction in the reaction tank 51 is considered to have converged, the system control circuitry 36 acquires, as a measured value, one value of data on the light intensity continuously supplied from the light detector 312.

In step S7, with the determination function 364, the system control circuitry 36 compares the measured value acquired in step S7 with the threshold value T_{A} stored in the storage 35, thereby determining, for example, positivity or negativity.

In step S8, with the output control function 365, the system control circuitry 36 presents or notifies the determination result to a user.

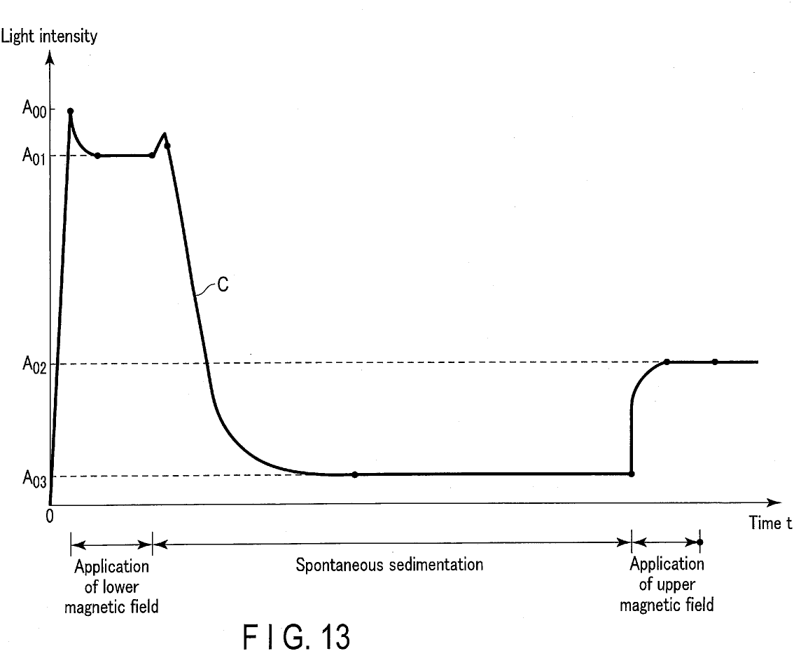

Next, an example of a chronological change in light intensity of emitted light will be described with reference to FIG. 13.

FIG. 13 is a graph C showing a chronological change in light intensity, in which the vertical axis indicates the light intensity and the horizontal axis indicates time.

When the sample liquid is dropped into the reaction tank 51 of the test device 1 and the reaction tank 51 is filled with the sample liquid, the light intensity to be measured increases. This is because the water-soluble film adhered to the upper surface of the optical waveguide including the reaction detector dissolves.

Thereafter, when a lower magnetic field is applied, as described above, the magnetic particles on which the second antibody is immobilized in the sample liquid in the reaction tank 51 are bound to the first antibody immobilized on the reaction detector 24 via the light source. In addition, the magnetic particles on which the second antibody is immobilized enter the sensing region one after another, thereby decreasing the light intensity. The rate of decrease in light intensity becomes smaller with time and converges to a certain light intensity value, for example A01 herein.

Thereafter, when the application of the lower magnetic field is stopped, the magnetic particles on which the second antibody is immobilized are released by the lower magnetic field and start spontaneous sedimentation. In addition, a so-called overshoot occurs during a predetermined time period after application of the lower magnetic field is stopped, and the light intensity turns to an increase and then after a short time period, to a decrease. After the overshoot converges, the light intensity decreases. This is because the magnetic particles on which the second antibody is immobilized enter the sensing region one after another, thereby increasing the rate of decrease. After the elapse of a certain time period, the spontaneous sedimentation of the magnetic particles on which the second antibody is immobilized also converges, and the light intensity converges to a certain light intensity value, the light intensity value of for example A₀₃ herein.

In the state in which the light intensity converges to the light intensity value of A₀₃, the magnetic particles on which the second antibody is immobilized remains in the sensing region. When near-field light is generated on the upper surface of the optical waveguide 22 while the magnetic particles remain in the sensing region, the magnetic particles remaining in the sensing region scatter and absorb this near-field light, thereby attenuating the near-field light. That is, by the near-field light being attenuated in the sensing region, the light guided through the inside of the optical waveguide 22 is also attenuated. In other words, the intensity of the light output from the optical waveguide 22 decreases as the amount of magnetic particles remaining in the reaction tank 51 increases.

However, the magnetic particles remaining in the reaction tank 51 are not limited to those in which the first antibody immobilized on the upper surface of the optical waveguide 22 via the antigen serving as a measurement target and the second antibody immobilized on the magnetic particles are bound together. Therefore, in order to accurately measure the concentration of the antigen contained in the detection target substance, the magnetic particles not involved in the measurement, that is, the magnetic particles on which the second antibody not bound to the antigen is immobilized need to be moved away from the reaction tank 51. Therefore, by applying the upper magnetic field, the magnetic particles on which the second antibodies that have not been aligned are immobilized move away from the sensing region, so that they can be suspended again in the reaction tank 51.

As a result, the magnetic particles that eventually remain in the sensing region are those in which the first antibody immobilized on the upper surface of the optical waveguide 22 via the antigen and the second antibody are bound together, and the light intensity converges to a certain light intensity value, the light intensity value of, for example, A₀₂ herein.

According to the second embodiment described above, even with a very small amount of sample liquid, a test on a detection target substance can be performed under the test system using the test device according to the first embodiment.

Herein, the term “processor” used in the above explanation means, for example, circuitry such as a central processing unit (CPU), a graphics processing unit (GPU), an application-specific integrated circuit (ASIC), or a programmable logic device (e.g., a simple programmable logic device (SPLD), a complex programmable logic device (CPLD), or a field-programmable gate array (FPGA)). In the case of the processor being a CPU, for example, the processor implements a function by reading and executing a program stored in a storage. On the other hand, in the case of the processor being, for example, an ASIC, instead of a program being stored in a storage, a corresponding function is directly incorporated as a logic circuit in the circuit of the processor. Each processor of the present embodiment is not limited to a configuration as a single circuit; a plurality of independent circuits may be combined into one processor to implement the function of the processor. Furthermore, a plurality of components in the drawings may be integrated into one processor to implement their functions.

According to at least one of the above-described embodiments, the examination convenience and efficiency can be improved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A test kit comprising:
a dropping device configured to drop a droplet; and
a test device including:
a reaction tank having an opening into which the droplet is dropped, the reaction tank being configured to house the droplet; and
a reaction detector arranged below the opening inside the reaction tank and comprising a surface with a substance to be bound to a detection target substance, and
the reaction tank has an internal volume substantially equal to twice an amount of the droplet, or smaller than or equal to twice the amount.

2. The test kit according to claim 1, wherein the reaction tank enters a filled state in which the reaction tank is filled with the droplet, in a case where the droplet is dropped into the reaction tank.

3. The test kit according to claim 2, wherein the filled state is a state in which an upper surface and a lower surface of the reaction tank are in contact with the droplet.

4. The test kit according to claim 1, wherein the amount of the droplet corresponds to one droplet or two droplets by the dropping device.

5. The test kit according to claim 1, wherein the reaction detector includes a plurality of detection regions, and
each of the detection regions contains an antibody for measuring whether or not the droplet contains a detection target substance.

6. The test kit according to claim 5, wherein the reaction detector further includes a liquidphobic nondetection region by which each of the detection regions serves as an independent region.

7. The test kit according to claim 1, wherein a size of the opening is determined according to an outer diameter of a tip of the dropping device from which the droplet is dropped.

8. The test kit according to claim 1, wherein a size of the opening is larger than a diameter of the droplet to be dropped from the dropping device.

9. The test kit according to claim 1, wherein the opening is formed at a position in a vicinity of a center of the reaction detector, where the droplet is dropped.

10. The test kid according to claim 1, further comprising a first assisting structure protruding from a housing of the test device toward an outside, arranged around the opening, and configured to assist in guiding the droplet to the opening.

11. The test kit according to claim 1, further comprising a second assisting structure extending from the opening to an inside of the reaction tank and configured to assist in guiding the droplet to the reaction detector.

12. The test kit according to claim 1, wherein the opening is formed in a top surface of the reaction tank, and
the test kit further comprises a third assisting structure protruding from the top surface toward an inside of the reaction tank.

13. The test kit according to claim 10, wherein at least one of the first assisting structure and the third assisting structure has a concave structure centered on the opening.

14. The test kit according to claim 10, wherein at least one of the first assisting structure and the second assisting structure has a surface structure that suppresses a surface tension of the droplet.

15. The test kit according to claim 14, wherein the surface structure has at least one of a fine uneven structure and a lyophilic structure.

16. The test kit according to claim 1, wherein the opening is formed in a top surface of the reaction tank, and
the top surface has at least one of a fine uneven structure and lyophilicity.

17. The test kit according to claim 1, wherein the surface of the reaction detector has lyophilicity.

18. A test system comprising the test kit according to claim 1 and a measuring device, wherein
the test device further includes:
a first grating configured to cause light to enter a region inside the reaction tank filled with the droplet, the region serving as an optical waveguide; and
a second grating configured to emit light having transmitted through the optical waveguide to an outside, and
the measuring device includes:
a light source;
a light detector configured to receive light from the second grating; and
a detector configured to measure a substance amount of the detection target substance contained in the droplet in the reaction tank by detecting an optical change and to generate a measurement result of the detection target substance.
